(19) United States
(12) Patent Application Publication
(10) Pub. No.: US 2022/0202046 A1
(43) Pub. Date: Jun. 30, 2022

(54) Packaged Food Product and Method of Producing the Packaged Food Product

(71) Applicant: Blue Buffalo Enterprises, Inc., Wilton, CT (US)

(72) Inventors: Daniel Christopher Budd, West Vancouver (CA); Jacqueline Iversen, Minneapolis, MN (US); Trond Erik Tollefsen, London (GB)

(73) Assignee: Blue Buffalo Enterprises, Inc., Wilton, CT (US)

(21) Appl. No.: 17/136,152

(22) Filed: Dec. 29, 2020

(51) Int. Cl. A23K 40/00; B65D 1/30; B65D 1/40; B65D 77/20; B65B 69/00; A23K 50/48

(52) U.S. Cl. CPC A23K 40/00; B65D 1/30; A23K 50/48; B65D 77/2024; B65B 69/0058; B65D 1/40

(57) ABSTRACT

A packaged food product includes a container and a food product. The container has a rim and at least one sidewall extending from the rim to a bottom wall. The at least one sidewall and the bottom wall define a storage area, and the food product is retained within the storage area such that the food product is in contact with the at least one sidewall. The at least one sidewall is readily deformable by a hand of a user to reduce a volume of the storage area. Finger engaging recesses are formed in the bottom wall to assist in deforming the container, with reducing the volume of the storage area causing the food product to exit the storage area. The bottom wall of the container includes an integral tool portion for breaking up and/or tenderizing the food product after removal from the storage area. The food product can be a wet cat or dog food.

### BACKGROUND OF THE INVENTION

The present invention pertains to the art of food production and, more particularly, to packaging for food products.

Food products are often packaged prior to sale. Such packaging can take the form of cans, jars, boxes or bags, for example. In the case of pet food, such as wet cat or dog food, cans are a common packaging type. When the wet food is served, consumers frequently remove the food from the can and place it into or onto a bowl, dish or plate, for example, where the food may then be broken up or otherwise prepared for serving. This requires a spoon or fork, both for the serving and the chopping. However, many consumers would prefer not to use a utensil for this task that they themselves also eat with, necessitating the ownership of one or more dedicated pet food utensils. At the very least, this process results in additional dirty utensils that must be cleaned. Accordingly, it would desirable to provide a way for consumers to serve wet pet food without using a utensil.

In addition, one reason why a consumer might use a utensil to serve wet pet food from a can is that the can contains multiple servings and the consumer only wishes to serve part of the can's contents. Accordingly, it would also be desirable to provide wet pet food in single-serve packaging.

### SUMMARY OF THE INVENTION

The present invention achieves the above goals through the use of packaging that is readily deformable by hand, with the deformation causing the contents of the packaging to exit the packaging. Preferably, the packaging is sized to provide a single serving. Additionally, the packaging includes structure to help break up and/or tenderize the contents after they have been dispensed.

In particular, a packaged food product comprises a container and a food product. The container includes a body having at least one sidewall extending away from a supporting rim and leading to a bottom wall. The at least one sidewall and the bottom wall define a storage area for retaining the food product. The at least one sidewall is configured to be readily deformable by a hand of a user to reduce a volume of the storage area. To assist in deforming the sidewall, the bottom wall of the body includes pre-formed finger recesses. The packaged food product is configured such that reducing the volume of the storage area causes the food product to exit the storage area. The food product can take various forms, such as a wet cat food or a wet dog food. Also, the bottom wall of the body is provided, between the finger recesses, with a series of projections collectively defining a tool portion of the container. Upon removing the food from the storage area of the container, the tool portion can be advantageously employed to further prepare the food prior to serving. For instance, when the food includes meat, the projections can be used to press the meat in order to break-up and/or tenderize the meat or other solid portions, while avoiding the need to dirty a separate utensil.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a perspective view of two packaged food products produced in accordance with the present invention.

FIG. 2 is a perspective view of the two packaged food products of FIG. 1, but with a lid or seal on one of the packaged food products partially peeled away to expose a food product.

FIG. 3 is a top view of a container of the packaged food product of FIG. 2, with the food product omitted.

FIG. 4 is a side view of the container.

FIG. 5 is a perspective view of the container showing the bottom of the container being used to break up and/or tenderize the food product.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting but merely as a representative basis for teaching one skilled in the art how to construct and employ the present invention.

As discussed above, pet food, such as wet cat or dog food, is commonly packaged in cans. To serve such pet food, a consumer would use a separate utensil to remove the pet food from the can and break it up. In some cases, only a portion of the pet food is removed from the can. This process necessitates the cleaning of the utensil and, for some consumers, a dedicated pet food utensil. The present invention was developed to address this problem. Specifically, the present invention provides a container with a body defined by at least one sidewall and a bottom wall which establish a storage area for retaining a food product, with the at least one sidewall being readily deformable by hand to reduce a volume of the storage area. Reducing the volume of the storage area causes the food product to exit the storage area. In other words, the user can squeeze the container to dispense the food, avoiding the need for a separate utensil. The bottom wall of the container preferably includes a pair of preformed finger recesses to assist in deforming the container and expelling the food. The container is preferably sized to hold a single serving of the food product. Therefore, the user does not need to try to serve only a portion of the food product. In addition, a portion of the bottom wall of the container, between the finger recesses, is formed with a plurality of spaced projections which establish an integrally formed tool portion of the container. This structure can be used to further process the food prior to serving, specifically by breaking up and/or tenderizing the food product after it has been dispensed, while again avoiding the need for a separate utensil.

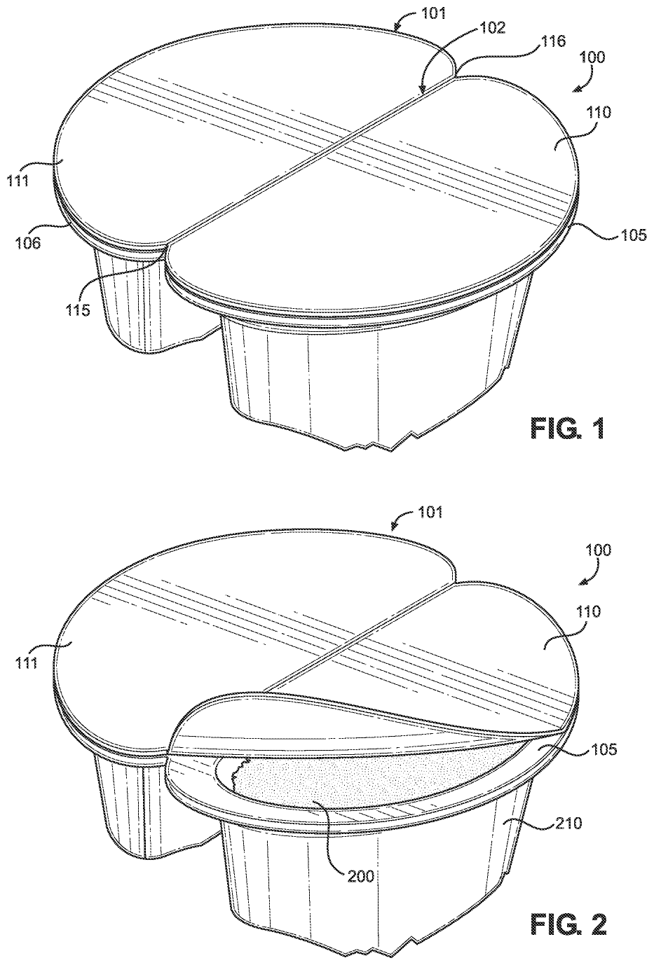

With reference to FIG. 1, two symmetrical, mirror image packaged food products 100 and 101 are shown. Packaged food products 100 and 101 are attached to one another and can be sold as a unit. However, it should be recognized that packaged food products 100 and 101 can also be sold individually or in larger quantities (with additional packaged food products attached thereto).

Packaged food products 100 and 101 are functionally identical but their shapes are mirror images of one another, with the plane of symmetry being located at their point (connection line 102) of attachment. More particularly, packaged food product 100 has a rim 105 and a lid 110 in sealing contact with rim 105, while packaged food product 101 has a rim 106 and a lid 111 in sealing contact with rim 106. Rim 105 is attached to rim 106 to attach packaged food products 100 and 101 to one another. This connection is obscured by lids 110 and 111 but generally extends between points 115 and 116. Packaged food products 100 and 101 can be attached by molding a single substrate and then blow molding two containers from the substrate, for example. When desired, packaged food products 100 and 101 can be readily detached from each other through a back and forth bending operation about connection line 102 extending between points 115 and 116. Since packaged food product 101 is nearly identical to packaged food product 100, packaged food product 101 will not be discussed further.

Turning to FIG. 2, packaged food product 100 is shown with lid 110 peeled partially away from rim 105 to expose a food product 200. Food product 200 is a single serving of a wet pet food, e.g., wet cat food or wet dog food. However, food product 200 can take other forms in other embodiments. Rim 105 and lid 110 form part of a container 205, which is configured to retain food product 200. Container 205 further includes a sidewall 210 extending away from rim 105, with sidewall 210 being shown to be an annular wall.

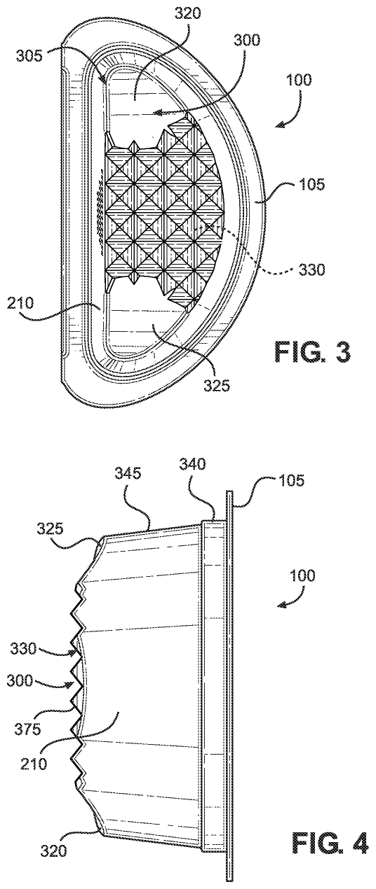

In FIG. 3, food product 200 is omitted so that a bottom wall 300 of container 205 can be seen. Sidewall 210 and bottom wall 300 together define a storage area 305 in which food product 200 is retained. As should be recognized based on FIGS. 2 and 3, food product 200 is in contact with bottom wall 300 during storage and is typically in contact with at least part of sidewall 210 as well. While one exemplary arrangement for sidewall 210 and bottom wall 300 has been illustrated, it should be understood that many different arrangements can be used in accordance with the present invention. In other words, the shape of storage area 305 can vary. For example, the single sidewall 210 can be replaced with multiple walls, or sidewall 210 and bottom wall 300 can be combined, with storage area 305 taking on a hemispherical shape. In general, container 205 should have at least one wall defining storage area 305.

Preferably, molding, such as blow molding, is used to create sidewall 210, bottom wall 300 and storage area 305. In a preferred form, a flat plastic substrate in the shape of rim 105 is subjected to blow molding to cause the center of the substrate to expand. The expansion is controlled in such a way that the center portion becomes sidewall 210 and bottom wall 300, thereby also forming storage area 305. Based on the construction of the overall mold used to make container 205, the bottom wall is preferably formed with a pair of spaced finger recesses 320 and 325, as well as a central tool portion 330, as will be discussed in detail below. In any case, as a result of this formation process, sidewall 210 and bottom wall 300 are magnitudes thinner than rim 105. In particular, by this construction, the thickness of sidewall 210 and bottom wall 300 is established so that at least one of sidewall 210 and bottom wall 300 is readily deformable. For purposes of the present invention, by “readily deformable” it is meant that a user can deform sidewall 210 or bottom wall 300 by hand (i.e., using one or both hands and without any tools) without requiring an above average amount of strength. This allows the user to push one or both of sidewall 210 and bottom wall 300 inward (i.e., readily collapsing the same into storage area 305) to reduce the volume of storage area 305. In particular, a user can engage rim 105 with a finger or two from each hand while pushing upon bottom wall 300 with his/her thumbs arranged at finger recesses 320 and 325 to readily deform sidewall 210 and reduce the volume of storage area 305. Reducing the volume of storage area 305 causes food product 200 to exit storage area 305. As a result, the user can dispense food product 200 without using a utensil.

While the discussion above focuses on the structure of sidewall 210 and bottom wall 300, it should be recognized that the shapes of sidewall 210 and bottom wall 300 also have an effect on their deformability. Accordingly, this parameter is also adjusted to provide the desired degree of deformability. In general, at least one of the walls defining storage area 305 is configured to be readily deformable and has at least a slight taper from rim 105 to bottom wall 300 as perhaps best shown in FIG. 4. To further enhance the collapsing operation, sidewall 210 is also preferably tiered (shown in FIG. 4 with upper and lower tiered sections 340 and 345, but additional tiers could be provided).

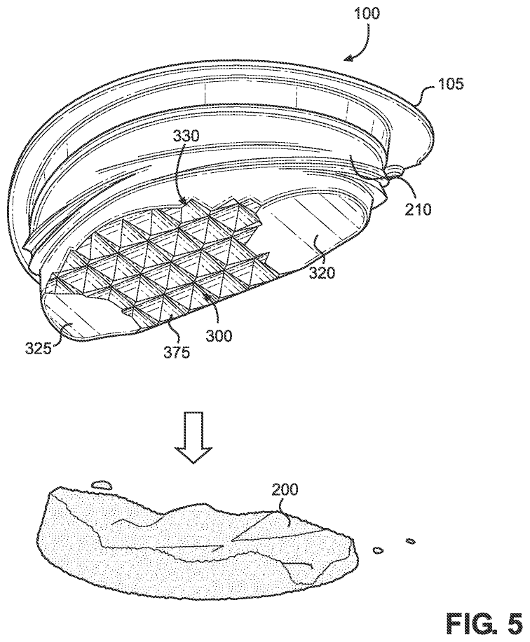

Turning further to FIGS. 4 and 5, central tool portion 330 is shown extending along part of bottom wall 300, specifically between the pair of spaced finger recesses 320 and 325 which along with tool portion 330 preferably defines bottom wall 300 in its entirety. Tool portion 330 is constituted by a plurality of adjacently arranged projections, one of which is labeled 375. In the preferred embodiment shown, projections 375 are pyramidal in shape so as to generally come to a sharp or rounded point, although other geometric shapes could be employed. With this construction, container 205 is integrally formed with tool portion 330. In particular, the user can use tool portion 330 to further process food product 200 prior to serving the food product. In particular, tool portion 330 can be manually pressed into food product 200 to break up and/or tenderize food product 200. This is particularly advantageous when food product 200 includes meat which can benefit from being broken up and/or tenderized prior to being consumed.

Based on the above, it should be readily apparent that the present invention provides a way for consumers to dispense wet pet food from a container without using a separate utensil. In addition, the invention provides for further processing the food prior to serving by using a specifically structured portion of the container to further process the food. While certain preferred embodiments of the present invention have been set forth, it should be understood that various changes or modifications could be made without departing from the spirit of the present invention. In general, the invention is only intended to be limited by the scope of the following claims.

1. A packaged food product comprising:
a container including at least one sidewall and a bottom wall which combine to define a storage area, said bottom wall having an integrally formed, tool portion; and
a food product retained within the storage area and in contact with the at least one sidewall, wherein the at least one sidewall is configured to be readily deformable by a hand of a user to reduce a volume of the storage area, and the packaged food product is configured such that reducing the volume of the storage area causes the food product to exit the storage area for further processing with the tool portion.

2. The packaged food product of claim 1, wherein the tool portion includes a plurality of spaced projections for use in breaking up and/or tenderizing the food product after the food product is removed from the storage area.

3. The packaged food product of claim 2, wherein each of the plurality of spaced projection is pyramidal shaped.

4. The packaged food product of claim 1, wherein the container further includes a rim extending around the least one sidewall, spaced from the bottom wall.

5. The packaged food product of claim 4, wherein the at least one sidewall tapers inward from the rim to the bottom wall.

6. The packaged food product of claim 5, wherein the at least one sidewall is tiered.

7. The packaged food product of claim 4, wherein the container further includes a lid in contact with the rim, with the lid sealing the storage area.

8. The packaged food product of claim 1, further comprising: a pair of spaced finger recesses formed in the bottom wall and configured to be engaged by a user in deforming the at least one sidewall.

9. The packaged food product of claim 8, wherein the tool portion extends along the bottom wall between the pair of spaced finger recesses.

10. The packaged food product of claim 9, wherein the bottom wall is entirely formed from the pair of spaced finger recesses and the tool portion.

11. The packaged food product of claim 1, wherein the food product is a wet cat food or a wet dog food.

12. The packaged food product of claim 1, wherein the container constitutes a first container, and the food product constitutes a first food product, the packaged food product further comprising a second container detachably connected to the first container and a second food product retained within the second container.

13. A method of serving a food product from a container including at least one sidewall and a bottom wall defining a storage area retaining the food product, and a tool portion integrally formed along part of the bottom wall, the method comprising:
reducing the volume of the storage area by manually deforming the at least one sidewall to reduce a volume of the storage area and cause the food product to exit the storage area; and
using the tool portion of the container to break up and/or tenderize the food product prior to serving the food product.

14. The method of claim 13, wherein using the tool portion includes manually pressing the tool portion into the food product.

15. The method of claim 14, wherein the tool portion includes a plurality of spaced projections for pressing into the food product in order to break up and/or tenderize the food product.

16. The method of claim 15, wherein pressing the tool portion into the food product includes pushing pyramidal shaped projections into the food product.

17. The method of claim 15, further comprising engaging a pair of spaced finger recesses formed in the bottom wall in deforming the at least one side wall.

18. The method of claim 13, wherein the container further includes a rim extending around the least one sidewall, spaced from the bottom wall, with the at least one sidewall tapering inward from the rim to the bottom wall, and wherein reducing the volume of the storage area includes collapsing the tapering at least one sidewall.

19. The method of claim 13, wherein the container further includes a lid sealed about the rim, said method further comprising peeling the lid from the rim to expose the food product prior to reducing the volume of the storage area.

20. The method of claim 13, further comprising: detaching the container from a symmetrical, mirror image container prior to peeling the lid.

21. The method of claim 13, wherein the food product is a wet cat food or a wet dog food.
